(19) United States
(12) Patent Application Publication
(10) Pub. No.: US 2007/0144455 A1
(43) Pub. Date: Jun. 28, 2007

(54) METHOD AND APPARATUS FOR DELIVERING OXYGENATED HEATED VAPOR IN SKIN CARE APPLICATIONS

(76) Inventors: Julian T. Ross, McKinney, TX (US); Steven O. Dunford, Lewisville, TX (US)

Correspondence Address: CARR LLP, 670 FOUNDERS SQUARE, 900 JACKSON STREET, DALLAS, TX, 75202, US

(21) Appl. No.: 11/560,304

(22) Filed: Nov. 15, 2006

Related U.S. Application Data
(60) Provisional application No. 60/736,786, filed on Nov. 15, 2005.
(60) Provisional application No. 60/763,121, filed on Jan. 27, 2006.

(51) Int. Cl. F02B 75/00

(52) U.S. Cl. 122/38; 122/DIG. 10; 261/DIG. 65

(57) ABSTRACT

A device generates liquid vapor mixed with oxygen rich gas for use in skin care, facial treatments and other dermatological applications and tissue treatments. The device consists of a portable vapor generator and an oxygen source. The oxygen source can be a portable source such as a compressed tank, a catalytic oxygen generator, an oxygen concentrator and the like.

### CROSS-REFERENCED APPLICATIONS

This application relates to, and claims the benefit of the filing date of, co-pending U.S. provisional patent application Ser. No. 60/736,786 entitled Method and Apparatus for Delivering Oxygenated Heated Vapor in Skin Care Applications, filed Nov. 15, 2005, and U.S. provisional patent application Ser. No. 60/763,121 entitled Method and Apparatus for Delivering Oxygenated Heated Vapor in Skin Care Applications, filed Jan. 27, 2006, the entire contents of which are incorporated herein by reference for all purposes. This application also relates to the following co-pending U.S. Patent Applications, the entire contents of which are incorporated herein by reference for all purposes:
1. Ser. No. 10/718,131 entitled Method & Apparatus for Generating Oxygen, filed Nov. 20, 2003;
2. Ser. No. 10/856,591 entitled Apparatus and Delivery of Medically Pure Oxygen, filed May 28, 2004;
3. Ser. No. 11/045,805 entitled Method and Apparatus for Controlled Production of a Gas, filed Jan. 28, 2005;
4. Ser. No. 11/158,993 entitled Method and Apparatus for Controlled Production of a Gas, filed Jun. 22, 2005;
5. Ser. No. 11/159,016 entitled Method and Apparatus for Controlled Production of a Gas, filed Jun. 22, 2005;
6. Ser. No. 11/158,377 entitled Method and Apparatus for Controlled Production of a Gas, filed Jun. 22, 2005;
7. Ser. No. 11/158,362 entitled Method and Apparatus for Controlled Production of a Gas, filed Jun. 22, 2005;
8. Ser. No. 11/158,618 entitled Method and Apparatus for Controlled Production of a Gas, filed Jun. 22, 2005;
9. Ser. No. 11/158,989 entitled Method and Apparatus for Controlled Production of a Gas, filed Jun. 22, 2005;
10. Ser. No. 11/158,696 entitled Method and Apparatus for Controlled Production of a Gas, filed Jun. 22, 2005;
11. Ser. No. 11/158,648 entitled Method and Apparatus for Controlled Production of a Gas, filed Jun. 22, 2005;
12. Ser. No. 11/159,079 entitled Method and Apparatus for Controlled Production of a Gas, filed Jun. 22, 2005;
13. Ser. No. 11/158,763 entitled Method and Apparatus for Controlled Production of a Gas, filed Jun. 22, 2005;
14. Ser. No. 11/158,865 entitled Method and Apparatus for Controlled Production of a Gas, filed Jun. 22, 2005;
15. Ser. No. 11/158,958 entitled Method and Apparatus for Controlled Production of a Gas, filed Jun. 22, 2005;
16. Ser. No. 11/158,867 entitled Method and Apparatus for Controlled Production of a Gas, filed Jun. 22, 2005;
17. Ser. No. 60/699,094 entitled Method and Apparatus for Generating Oxygen, filed Jul. 14, 2005;
18. Ser. No. 60/742,436 entitled Flexible Reaction Chamber with Frangible Seals and activation methods, filed Dec. 5, 2005;
19. Ser. No. 60/736,786 entitled Method and Apparatus for Delivering Oxygenated Heated Vapor in Skin Care Applications, filed Nov. 15, 2005;
20. Ser. No. 60/735,011 entitled Oxygen Patch, filed Nov. 15, 2005;
21. Ser. No. 60/742,436 entitled Flexible Reaction Chamber with Frangible Seals and Activation Methods filed Dec. 5, 2005;
22. Ser. No. 60/759,255 entitled Method and Apparatus for Providing Improved Availability of Breathable Air in a Closed Circuit filed Jan. 13, 2006;
23. Ser. No. 60/814,340 entitled Method and Apparatus for Providing Improved Availability of Breathable Air in a Closed Circuit filed Jun. 16, 2006;
24. Ser. No. 60/829,639 entitled Method and Apparatus for Providing Improved Availability of Breathable Air in a Closed Circuit filed Oct. 16, 2006; and
25. Ser. No. 60/762,675 entitled Expandable Housing Generator filed Jan. 27, 2006; and
26. Ser. No. 11/558,374 entitled Method and Apparatus For Delivering Therapeutic Oxygen Treatments, filed Nov. 9, 2006

### BACKGROUND OF THE INVENTION

1. Field of the Invention

The present invention relates to dermatological treatments and, more particularly, to methods and apparatus for generating and delivering to a bodily area a liquid vapor enriched with oxygen or an oxygen rich gas.

2. Description of Related Art

Appliances for steam generation and facial saunas or steamers are well known in the prior art. These devices are all designed to provide steam to the skin or facial area in one way or another. However, none of the devices in the prior art make provision for the combination of steam or vapors with an oxygen enriched gas to provide oxygenated steam or saturated oxygen to the skin or facial area for increased health and wellness benefits in a manner that is safe, compact, easy-to-manufacture, affordable and suitable for consumer use. More generally, none of the inventions in the prior art provide for the generation and delivery to the facial area of liquid vapor enriched with oxygen or an oxygen rich gas.

The healing effects and cosmetic benefits of enriched oxygen applied to the human skin are widely accepted and are supported by recent studies. Many skin care products such as creams and potions claim to have oxygen contained therein, and these products proclaim the benefits of the oxygen content but the oxygen content is actually miniscule thereby offering little of the beneficial effects of oxygen. This invention can provide pure oxygen.

It is therefore an object of this invention to provide a safe and consumer-friendly device that provides a mixture of liquid vapor or droplets and an oxygen rich gas for use on the skin generally and to the facial area more specifically.

It is further an object of this invention to provide an oxygen source that can be contained in non-pressurized cartridges or pouches that can be safely disposed of and replaced after use. Cartridges or pouches for the unit generate oxygen safely and on demand via a catalytic chemical reaction involving an inert oxidizing substance and a catalyst, with or without the presence of water or other suitable accelerant, thereby eliminating the dangers that may typically be associated with traditional oxygen sources, such as compressed tanks.

### SUMMARY OF THE INVENTION

A device generates liquid vapor mixed with oxygen rich gas for use in skin care, facial treatments and other dermatological applications and tissue treatments. The device consists of a portable vapor generator and an oxygen source, either provided as two or more separate portable devices, which can also be combined as one portable device. The oxygen source can be a portable source such as a catalytic oxygen generator, a pressurized tank of compressed oxygen, an oxygen concentrator and the like. The device also provides for the introduction of additional materials, in vaporized, sublimated or evaporated form, for use in combination with the oxygen to enhance the beneficial effects.

### BRIEF DESCRIPTION OF THE DRAWINGS

FIG. 1 is a perspective view of an embodiment of an assembled liquid vaporizer and a catalytic oxygen source contained in a flexible pouch;

FIG. 2 is a cross-sectional view of the embodiment of FIG. 1 taken along the lines 2-2;

FIG. 3A is a perspective view of a first apparatus that produces vapor and oxygen rich gas combined;

FIG. 3B is a perspective view of a second apparatus that produces vapor and oxygen rich gas combined;

FIG. 4 is a cross-sectional view of the apparatus of FIG. 3A taken along the lines 4-4;

FIGS. 5A-5B are perspective views of further liquid vaporizer assemblies having alternatively shaped vapor directors;

FIG. 6 is a cross-sectional view of liquid vaporizer incorporating an active flow device;

FIG. 7 is a cross-sectional view of a liquid vaporizer incorporating directional nozzles for directing the flow;

FIG. 8 is a perspective view of a liquid vaporizer incorporating a removable cartridge for containing a catalytic reactant mixture; and

FIG. 9 is a perspective view of a liquid vaporizer incorporating an ultrasonic excitation source.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

Reference is made herein to “Reaction Devices and Process” which are described in the following co-pending U.S. Patent Applications, the entire contents of which are incorporated herein by reference for all purposes:
1. Ser. No. 10/718,131 entitled Method & Apparatus for Generating Oxygen, filed Nov. 20, 2003;
2. Ser. No. 10/856,591 entitled Apparatus and Delivery of Medically Pure Oxygen, filed May 28, 2004;
3. Ser. No. 11/045,805 entitled Method and Apparatus for Controlled Production of a Gas, filed Jan. 28, 2005;
4. Ser. No. 11/158,993 entitled Method and Apparatus for Controlled Production of a Gas, filed Jun. 22, 2005;
5. Ser. No. 11/159,016 entitled Method and Apparatus for Controlled Production of a Gas, filed Jun. 22, 2005;
6. Ser. No. 11/158,377 entitled Method and Apparatus for Controlled Production of a Gas, filed Jun. 22, 2005;
7. Ser. No. 11/158,362 entitled Method and Apparatus for Controlled Production of a Gas, filed Jun. 22, 2005;
8. Ser. No. 11/158,618 entitled Method and Apparatus for Controlled Production of a Gas, filed Jun. 22, 2005;
9. Ser. No. 11/158,989 entitled Method and Apparatus for Controlled Production of a Gas, filed Jun. 22, 2005;
10. Ser. No. 11/158,696 entitled Method and Apparatus for Controlled Production of a Gas, filed Jun. 22, 2005;
11. Ser. No. 11/158,648 entitled Method and Apparatus for Controlled Production of a Gas, filed Jun. 22, 2005;
12. Ser. No. 11/159,079 entitled Method and Apparatus for Controlled Production of a Gas, filed Jun. 22, 2005;
13. Ser. No. 11/158,763 entitled Method and Apparatus for Controlled Production of a Gas, filed Jun. 22, 2005;
14. Ser. No. 11/158,865 entitled Method and Apparatus for Controlled Production of a Gas, filed Jun. 22, 2005;
15. Ser. No. 11/158,958 entitled Method and Apparatus for Controlled Production of a Gas, filed Jun. 22, 2005;
16. Ser. No. 11/158,867 entitled Method and Apparatus for Controlled Production of a Gas, filed Jun. 22, 2005;
17. Ser. No. 60/699,094 entitled Method and Apparatus for Generating Oxygen, filed Jul. 14, 2005;
18. Ser. No. 60/742,436 entitled Flexible Reaction Chamber with Frangible Seals and activation methods, filed Dec. 5, 2005;
19. Ser. No. 60/736,786 entitled Method and Apparatus for Delivering Oxygenated Heated Vapor in Skin Care Applications, filed Nov. 15, 2005;
20. Ser. No. 60/735,011 entitled Oxygen Patch, filed Nov. 15, 2005;
21. Ser. No. 60/742,436 entitled Flexible Reaction Chamber with Frangible Seals and Activation Methods filed Dec. 5, 2005;
22. Ser. No. 60/759,255 entitled Method and Apparatus for Providing Improved Availability of Breathable Air in a Closed Circuit filed Jan. 13, 2006;
23. Ser. No. 60/814,340 entitled Method and Apparatus for Providing Improved Availability of Breathable Air in a Closed Circuit filed Jun. 16, 2006;
24. Ser. No. 60/829,639 entitled Method and Apparatus for Providing Improved Availability of Breathable Air in a Closed Circuit filed Oct. 16, 2006; and
25. Ser. No. 60/762,675 entitled Expandable Housing Generator filed Jan. 27, 2006.
26. Ser. No. 11/558,374 entitled Method and Apparatus for Delivering Therapeutic Oxygen Treatments, filed Nov. 9, 2006

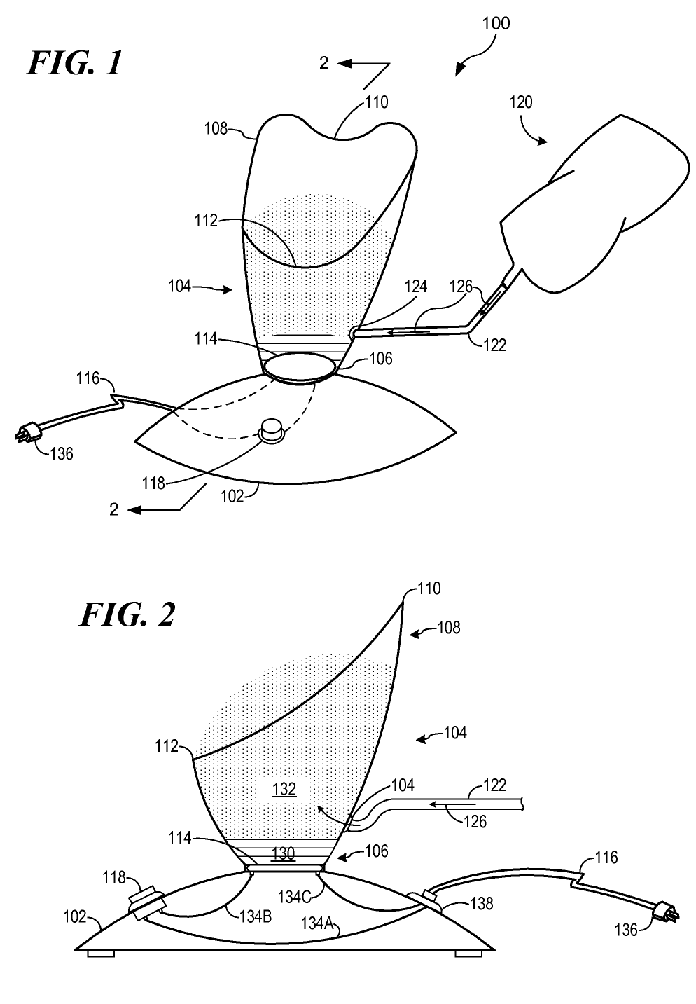

One embodiment of the invention comprises an electrically powered device to produce liquid vapor and a catalytic oxygen source contained in a flexible pouch, shown in FIG. 1. The pouch is displayed exposed for illustrative purposes. Cartridges or pouches can be located in the fixture base or in a separate container. A liquid vaporizer 100 comprises base 102 supporting a contoured vapor directing element 104. The contoured vapor directing element 104 can be a generally conical shape having a relatively small distal end 106 coupled to the base 102 and a relatively larger proximal end 108 through which an oxygenated vapor can be delivered to a treatment area. The proximal end 108 has a perimeter which can be shaped to fit a desired treatment area, for example; a facial area of a user. The vapor directing element 104 as shown in FIG. 1 is preferably shaped to rest the user's face in a downward direction, facing the distal end 106 of the element 104, but far enough away from it, in the path of the vapor being generated, along its perimeter in a manner as to comfortably seal the user's face to the vapor directing element 104. For example, the user's forehead can rest along section 110, and the user's chin would rest along section 112.

The liquid vaporizer 100 further comprises heating element 114, such as a grid, bowl or plate that heats up once an energy source is provided to it, disposed at the distal end 106 of vapor directing element 104 and supported by the base 102. The heating element 114 can be made of but is not limited to any of a large number of metals and or ceramic elements. Some high temperature resistant polymers may also be suitable for the process of heating liquids through resistive or inductive heating. The distal end 106 of vapor directing element 104, coupled to base 102 with heating element 114 disposed therebetween, preferably forms a vessel for holding a liquid such as water. The liquid vaporizer 100 further comprises a means for accepting a power or energy source, such as power cord 116, and a power control such as switch 118 coupled via electrical conductors 134 to the heating element 106.

The liquid vaporizer 100 further comprises an oxygen source 120 coupled via a conduit 122 to a port 124 formed in the side of vapor directing element 104. The oxygen source 120 can be a catalytic oxygen source. For example, the above-referenced patent applications, collectively referred to as “Reaction Devices and Processes”, describe various ways of providing this catalytic oxygen source. Alternatively, the oxygen source 120 can be a catalytic oxygen source using hydrogen peroxide as the oxygen releasing agent, such as is more fully described in US Patent Publication No. 2005/0022810, by Moore et al. Furthermore, another embodiment of the invention can include a pressurized tank of compressed oxygen, an oxygen concentrator or a liquid oxygen source interchangeably as the source of an oxygen rich gas 126.

Turning now to FIG. 2, the liquid vaporizer 100 further provides for a liquid 130 to be added to or otherwise brought into contact with the heat generated by heating element 114, causing a liquid vapor 132 to be created. Power cord 116 can be coupled to a typical electrical outlet (not shown) at plug 136 at a distal end thereof, and brought into base 102 through a suitable strain-relief means such as a grommet 138 at a proximal end thereof The power cord 116 can be coupled to power control 118 via a first electrical conductor 134A electrically connected to a first conductor of power cord 118 and to a first terminal on power control 118. The power control 118 can be coupled to heating element 114 via a second electrical conductor 134B connected to a second terminal on power control 118 and to a first terminal on heating element 114. The heating element 114 can be coupled to power cord 116 via a third electrical conductor 134C connected to a second terminal on heating element 114 and to a second conductor of power cord 118. Power control 118 can be actuated to an “ON” position to apply electrical power to heating element 114, causing the heating element 114 to heat-up and transfer heat energy to the liquid 130. The liquid 130 added to or otherwise brought into contact with heating element 114 can be water or it can be any suitable liquid providing a moist warm oxygen-rich environment that can be enhanced with the introduction of additional beneficial materials. For example, the liquid 130 can be a liquid flavorant or aromatic material, or it can be water containing additives, fragrances or other substances, chemicals or liquids to cause the vapor to be flavored, or otherwise accentuated with aromatic influences or experiences. Other beneficial nutrients or medications can include but are not limited to nutraceuticals, pharmaceuticals, anti-biotic and anti-microbial agents, essential oils, vitamins and/or scents. These agents can be introduced as a liquid or dissolvable solid, and/or introduced into the oxygen flow. If the liquid comprises water, then steam is simply generated in the process.

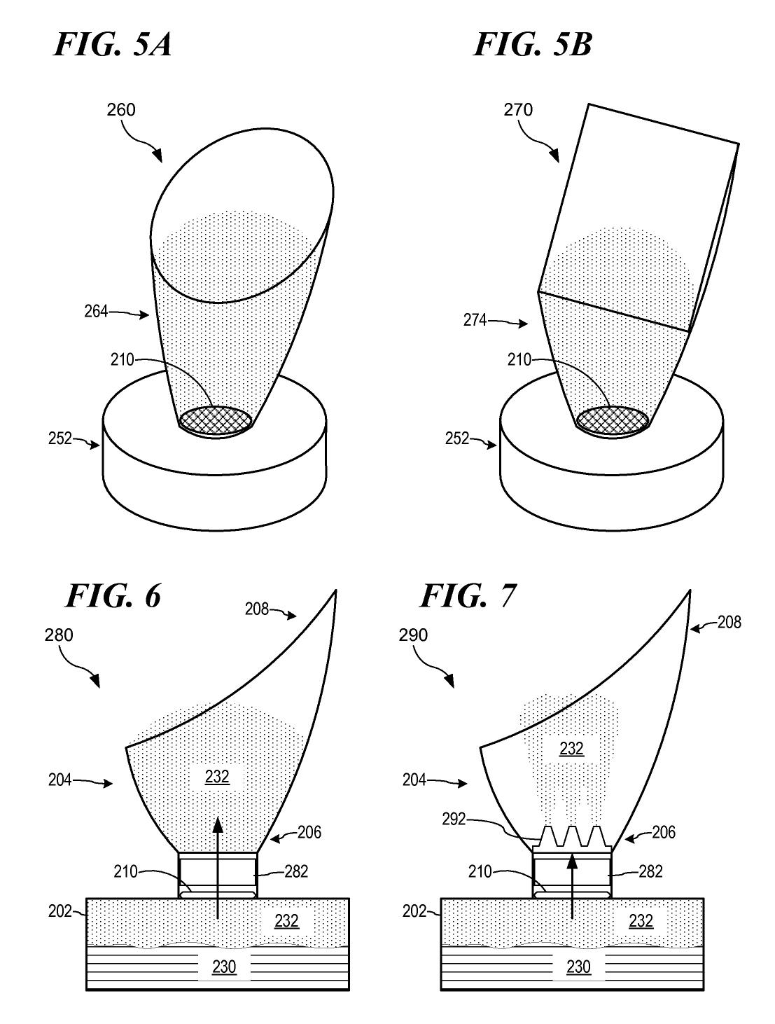

The liquid vaporizer 100 further comprises passive or active means for directing the vapor 132 to or concentrate the vapor 132 on the skin or facial area, as the case may be. The current embodiment, shown in FIG. 1 shows vapor directing element 104 can be designed to direct the vapor 132 generated by the heating element 114 to the facial area. Pressures are created from the oxygen generation process creating a flow of oxygen through the system. However, the method(s) used to direct the vapor to or concentrate the vapor on the skin can be any shape or form factor, depending on the area of the body that needs to be covered. For example, the shape could be a rectangle, circle or oval as shown in FIGS. 5A-5B. Applications using fans or other devices to create, increase and or direct a flow of the vapor laden oxygen are possible. Designs including directional jets or other orifices to direct or concentrate the flow on specific areas are also envisioned providing not only the oxygen rich vapor but also to provide a gentle messaging effect through the impingement of a constant or pulsed flow onto the desired areas. Once the liquid vapor 132 is being generated, the oxygen source 120 is activated to cause the oxygen rich gas 126 to flow through the tube 122 to port 124 and mix with the generated vapor 132 inside the vapor directing element 104.

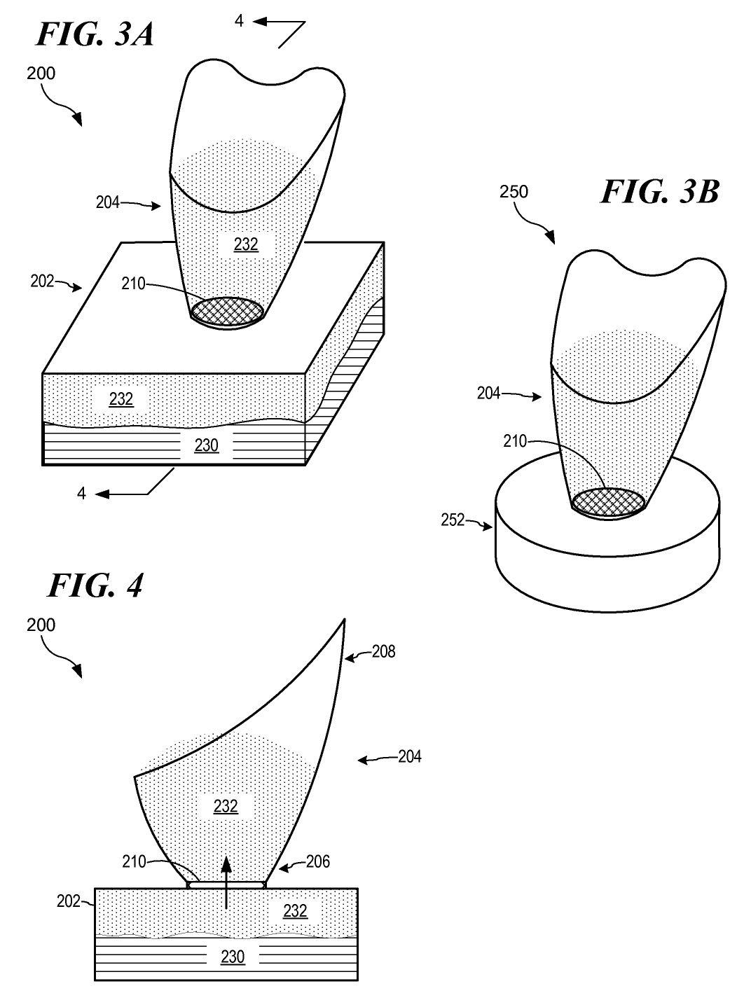

Turning now to FIGS. 3A and 3B, and in another embodiment, the energy source to create the vapor can be provided by a catalytic means, such as an exothermic chemical reaction. The heat or enthalpy generated by the exothermic reaction provides the heat required to generate the vapor. In another embodiment still, the means for generating the liquid vapor and the oxygen rich gas and the means for providing the vapor and oxygen rich gas to the skin or facial area, as the case may be, can be combined into one, safe, easy to use, inexpensive and consumer friendly device. FIGS. 3A-3B and FIG. 4 illustrate a method and apparatus for achieving this. The Reaction Devices and Processes fully describe the catalytic process for generating an oxygen rich gas. In accordance with these inventions, two inert powders (one an oxygen releasing agent and one a catalyst) are mixed with water or other appropriate liquid to produce an oxygen rich gas. The associated chemical reaction is an exothermic reaction and therefore produces heat. Furthermore, since the reaction requires the use of water or other appropriate liquid, the chemical reaction can be designed to produce oxygen or an oxygen rich gas that is saturated with the water or liquid being used in the reaction. Therefore, the catalytic reaction can be configured to serve two functions: (1) to generate the heat to vaporize the water or liquid used in the chemical reaction, thereby creating the vapor; and (2) to generate the oxygen or the oxygen rich gas. The temperature of the oxygen generating reaction can be regulated by controlling the volume of water, the amount of catalyst, particle size, particle coatings, or the volume of reagent available for the reaction and combinations thereof. Oxygen and vapors are provided to the user at safe use temperatures that will not cause burns or discomfort to the user.

Turning now to FIG. 3A, a catalytic liquid vaporizer 200 comprises a base vessel 202 supporting a contoured vapor directing element 204. A catalytic reaction mixture 230 can be housed in base vessel 202, producing an oxygen-rich gas 232 when activated. The base vessel 202 can be made of any thermoplastic material, and can be any shape or size. For example, the base vessel 202 can be square or rectangular as in FIG. 3A, or it can be round or oval shaped as illustrated by base vessel 252 in FIG. 3B.

Turning now to FIG. 4, the contoured vapor directing element 204 can be a generally tapered shape having a relatively small distal end 206 coupled to the base 202 and a relatively larger proximal end 208 through which an oxygenated vapor can be delivered to a treatment area. The distal end 206 is open and coupled to a corresponding opening in a top surface of base vessel 202. The proximal end 208 has a perimeter which can be shaped to fit a desired treatment area, for example; a facial area of a user. Vapor directing element 204 can support the user's face if the device is to be used as an oxygenated facial steamer. The base vessel 202 is in intimate communication with vapor directing element 204 via a transfer element 210, conducting the oxygenated vapor 232 from the base vessel 202, once the chemical reaction has commenced, to the vapor directing element 204. For example, this transfer element 210 can be in the form of a baffle, or it could also be a membrane such as a Nylon, Polytetrafluoroethylene (PTFE) or Polypropylene membrane, or it could be a mesh such as, for example; a stainless steel mesh.

Turning now to FIG. 5A, a liquid vaporizer 260 comprises a base vessel 252 coupled to a contoured vapor directing element 264 having a circular or oval shaped proximal end 266 and tapering to a relatively smaller distal end 268. The distal end 268 is open and coupled to a corresponding opening in a top surface of base vessel 252. The proximal end 266 has a perimeter which can be shaped to fit a desired treatment area.

Turning now to FIG. 5B, a liquid vaporizer 270 comprises a base vessel 252 coupled to a contoured vapor directing element 274 having a rectangular shaped proximal end 276 and tapering to a relatively smaller distal end 278. The distal end 276 is open and coupled to a corresponding opening in a top surface of base vessel 252. The proximal end 278 has a perimeter which can be shaped to fit a desired treatment area.

Turning now to FIG. 6, a liquid vaporizer 280 comprises a base vessel 202 supporting a contoured vapor directing element 204. The contoured vapor directing element 204 can be a generally tapered shape having a relatively small distal end 206 coupled to the base 202 and a relatively larger proximal end 208 through which an oxygenated vapor can be delivered to a treatment area. The distal end 206 is open and coupled to a corresponding opening in a top surface of base vessel 202. The proximal end 208 has a perimeter which can be shaped to fit a desired treatment area, for example; a facial area of a user. Vapor directing element 204 can support the user's face if the device is to be used as an oxygenated facial steamer. The base vessel 202 is in intimate communication with vapor directing element 204 via a transfer element 210, conducting the oxygenated vapor 232 from the base vessel 202, once the chemical reaction has commenced, to the vapor directing element 204. Conduction of the vapor 232 can be enhanced by the use of an active air-handling device 282, such as a fan, a piezoelectric air pump, and the like.

Turning now to FIG. 7, a liquid vaporizer 290 comprises a base vessel 202 supporting a contoured vapor directing element 204 having incorporated therein one or more directional nozzles 292 for directing the flow of an oxygen-rich vapor.

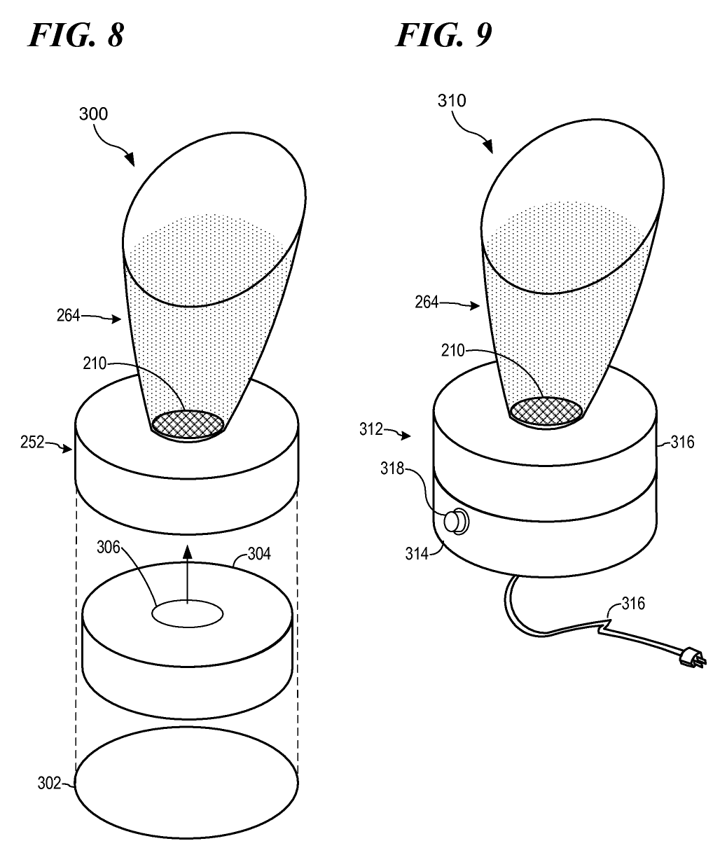

Turning now to FIG. 8, a liquid vaporizer 290 comprises a base vessel 252 having a removable cover 302, and supporting a contoured vapor directing element 264, further comprising a cartridge 304 containing a catalytic oxygen-generating mixture. The cartridge 304 can be docked or installed into the base vessel 252, for example, by removing cover 302, installing the cartridge 304, and replacing the cover 302. The cartridge can include an orifice 306 for coupling with the vapor directing element 264 via a transfer element 210 in the manner hereinbefore described.

The energy required to create the vapor can be introduced in many forms. For example, in another embodiment as shown in FIG. 9, the vapor can be generated using an excitation source in the ultrasonic frequency range. A liquid vaporizer 310 comprises a base vessel 312 having an ultrasonic excitation source 314 coupled to a power source through a suitable conductor, such as power cord 316, and controlled by a power control 318, such as a switch or other suitable control means. When energized, the ultrasonic excitation source 314 excites a liquid contained in a reservoir portion 316 of base vessel 312, thereby vaporizing a quantity of the liquid at some known or desired rate.

Droplets or inhaleable nano-powders of additional beneficial nutrients or medications as additives such as but not limited to nutraceuticals, pharmaceuticals, anti-biotic and anti-microbial agents, essential oils, vitamins and/or scents can be introduced into the oxygen flow. Materials introduced into the oxygen flow must be appropriate for inhalation without detrimental effects. Another option is to apply non-inhaleable materials directly to the skin prior to the exposure to the oxygen rich environment. Other means can be provided for use of materials that should not be inhaled. Nasal passages or other sensitive tissues would be isolated from the vapors with nose clips or plugs in combination with a breathing tube attached to a mouthpiece and gas-tight goggles. Rebreathers for emergency use in mines are illustrative of this application.

In another embodiment, the reservoir of small droplets, or micro-powders, are introduced into the flow of oxygen using piezoelectric pumps or other devices that produce fine droplets. This application would be similar to an interchangeable ink jet cartridge. Instead of ink small droplets of additional beneficial nutrients or medications would be add as desired. These additives can include but are not limited to nutraceuticals, pharmaceuticals, anti-biotic and anti-microbial agents, essential oils, vitamins and/or scents. This can be automatic or on demand actuation.

In another embodiment, the additional beneficial materials could be introduced through a manually operated spraying device as is commonly in use for dispensing liquids. The manual spraying device would provide the beneficial materials on demand at the user's discretion. In each case the additional beneficial materials can be supplied in bulk for refilling the reservoir, or as dockable cartridges that enable an easy change over to another material. The catalytic reaction materials would be provided in a dockable single-use disposable cartridge.

Other embodiments that can produce the desired effects could include; for example:

1. A device consisting of a portable vapor generator and an oxygen source, either provided as two separate portable devices or combined as one portable device. The oxygen source can be a portable source such as a catalytic oxygen generator, a pressurized tank of compressed oxygen, or it can be a source such as an oxygen concentrator. The device also provides for the introduction of additional materials for use in combination with the oxygen to enhance the beneficial or pleasurable effects.

2. A device that:

a. Uses a separate power source to produce vapor for use in combination with pure oxygen;
i. Heating elements or other heat sources can be used to produce the vapor;
ii. Ultrasonic energizing elements can be used to produce the vapor;
iii. An apparatus similar to an Ink Jet apparatus can be used to produce the vapor;
iv. Spray nozzles where a pressure is applied to atomize the desired liquid and create a mist or vapor can be manually operated (on-demand) or automatically actuated to produce the vapor;
v. Manual activation—Sprayers are an example of on-demand manual systems.

b. Requires no additional power source:
i. Exothermic reactions produce heat for producing a vapor;
ii. The use of the oxygen generating reaction to provide the energy needed to create the vapor(s).

c. Utilizes Passive Flow—Flow of the vapor and oxygen mix can be minimized by introducing the oxygen rich vapors through a large orifice;
1. Pressure generated from the catalytic oxygen generation reaction or from another source of oxygen such as compressed tanks provides the directional flow to carry the vapor away from the device and onto the skin. This could also be used for hygiene since individuals would not need to place their faces on the device, only in the flow from the device.

d. Utilizes Active Flow—Means are incorporated to increase the airflow including but not limited to fans or piezoelectric air pumps, etc. and can be used in combination with directional nozzles to concentrate the flow into localized areas.

e. Utilizes a Flow that can be constant or pulsed, wherein a pulsed flow creates the opportunity for gently massaging the skin with the use of directional nozzles.

f. Has the oxygen source or generator built into the disposable device.

g. Utilizes dockable and disposable cartridges or pouches to contain the oxygen generating materials and for the introduction of additional materials such as but not limited to:
i. nutrients or medications as additives such as nutraceuticals, pharmaceuticals, anti-biotic and anti-microbial agents, essential oils, vitamins and/or scents;
ii. Materials introduced into the oxygen flow must be appropriate for inhalation without detrimental effects; and
iii. non-inhaleable materials can be applied directly to the skin prior to the exposure to the oxygen rich environment.
   1. Other means can be provided for use of materials that should not be inhaled. Nasal passages or other sensitive tissues would be isolated from the vapors with nose clips or plugs in combination with a breathing tube attached to a mouthpiece and gas tight goggles. Rebreathers for emergency use in mines are illustrative of this application.

h. Provides for the temperature of the oxygen generating reaction to be regulated by controlling the volume of water, the amount of catalyst, particle size, particle coatings, or the volume of reagent available for the reaction and combinations thereof.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

We claim:

1. A vaporizer for treating tissue, comprising:
a portable vapor generator for creating vapor from a liquid or solid phase material contained by the vapor generator;
an oxygen source for delivery of oxygen-rich gas to the portable vapor generator; and
means for mixing oxygen-rich gas from the oxygen source with vapor created by the portable vapor generator and delivering the mixture to a treatment area of tissue.

2. The vaporizer of claim 1, wherein the portable vapor generator and the oxygen source are separate portable devices.

3. The vaporizer of claim 1, wherein the portable vapor generator and the oxygen source are combined into a single device.

4. A vaporizer, comprising:
a vessel for containing a liquid, having a liquid containing portion and a vapor directing portion;
a heating element coupled to the vessel, wherein the heating element is in thermal communication with a liquid placed in the vessel to thermally produce a vapor;
an oxygen source coupled to the vessel;
a conduit directing oxygen from the oxygen source to mix with the vapor, forming
a stream comprising a mixture of vapor and oxygen; and
a conduit directing at least a portion of the mixture of the oxygen and vapor into contact with an area of tissue to be treated by the mixture.
